(19) United States
(12) Patent Application Publication
(10) Pub. No.: US 2017/0153686 A1
(43) Pub. Date: Jun. 1, 2017

(54) DATA LOGGER AND COMPUTER-READABLE STORAGE MEDIUM APPLIED TO THE DATA LOGGER

(71) Applicant: Kabushiki Kaisha Toshiba, Tokyo (JP)

(72) Inventor: Shigeru Wakamatsu, Yokohama Kanagawa (JP)

(21) Appl. No.: 15/065,318

(22) Filed: Mar. 9, 2016

(30) Foreign Application Priority Data
Nov. 30, 2015 (JP) 2015-234133

(51) Int. Cl. G06F 1/32

(52) U.S. Cl. CPC G06F 1/3212; G06F 1/3234

(57) ABSTRACT

According to one embodiment, a data logger driven by a battery, includes a sensor, a log creation module, a detection module, a communication module, and a controller. The sensor measures a predetermined physical quantity. The log creation module creates a log based on the predetermined physical quantity. The detection module detects a take-over state that another data logger takes over creation of the log. The communication module communicates with said another data logger synchronized with the data logger. The controller performs a process to cause said another data logger to take over the creation of the log by communicating with said another data logger by the communication module when the take-over state is detected by the detection module.

### CROSS-REFERENCE TO RELATED APPLICATIONS

This application is based upon and claims the benefit of priority from Japanese Patent Application No. 2015-234133, filed Nov. 30, 2015, the entire contents of which are incorporated herein by reference.

### FIELD

Embodiments described herein relate generally to a data logger driven by a battery and a computer-readable storage medium applied to the data logger.

### BACKGROUND

In order to acquire data in different environments, usually, a data logger capable of recording the acquired data as a log is widely used. This data logger is driven by a battery because it is used in a situation where it cannot be charged.

In this data logger, continuous operating time such as time periods and days for which the data logger continuously operates, is one of the important indices indicating the performance of the data logger. Accordingly, the data logger employs a method of lengthening the continuous operating time by increasing the capacity of the battery.

Recently, however, it has been required to downsize a data logger. If the battery of the data logger simply increases in capacity, the downsizing becomes difficult. The increase in capacity upsizes the data logger itself and thus lowers the commercial value thereof.

Even though a single data logger increases in its battery capacity, the battery capacity will go dead to make it impossible to create a log continuously.

It has also been required to increase the storage capacity for recording a log created by a data logger. However, a large-capacity storage increases costs and, in this case, too, the commercial value of the data logger lowers.

### BRIEF DESCRIPTION OF THE DRAWINGS

FIG. 1 is a conceptual diagram showing an example of a logger control system of a first embodiment.

FIG. 2 is a functional block diagram showing an example of a configuration of a sensing logger of the first embodiment.

FIG. 3 is a flowchart showing an example of a logger control procedure to be performed by the sensing logger of the first embodiment.

FIG. 4 is a flowchart showing an example of a logger control procedure to be performed by another sensing logger of the first embodiment.

FIG. 5 is a conceptual diagram showing an example of a logger control system of a second embodiment.

FIG. 6 is a functional block diagram showing an example of a configuration of a sensing logger of the second embodiment.

FIG. 7 is a flowchart showing an example of a logger control procedure to be performed by the sensing logger of the second embodiment.

FIG. 8 is a flowchart showing an example of another logger control procedure to be performed by the sensing logger of the second embodiment.

FIG. 9 is a table showing an example of log data to be created by the sensing loggers of the first and second embodiments.

FIG. 10 is a perspective view showing an example of an outward appearance of the sensing loggers of the first and second embodiments.

### DETAILED DESCRIPTION

In general, according to one embodiment, a data logger driven by a battery, includes a sensor, a log creation module, a detection module, a communication module, and a controller. The sensor measures a predetermined physical quantity. The log creation module creates a log based on the predetermined physical quantity. The detection module detects a take-over state that another data logger takes over creation of the log. The communication module communicates with said another data logger synchronized with the data logger. The controller performs a process to cause said another data logger to take over the creation of the log by communicating with said another data logger by the communication module when the take-over state is detected by the detection module.

### First Embodiment

A first embodiment according to the present invention will be described below with reference to the accompanying drawings.

First, an overview of the first embodiment will be described with reference to FIG. 1. FIG. 1 is a diagram showing a logger control system 1 in the first embodiment.

In the first embodiment, a sensing logger 10a is placed as a data logger for freight in, e.g. a box containing freight such as a baggage. The sensing logger 10a is a data logger that acquires sensing information as a log. The sensing information includes climate information about climate such as atmospheric pressure, temperature and humidity, environment information such as oscillation and acceleration, and event information about an event such as impact and light quantity. This event will be described later. The log is referred to as data on which sensing information is recorded. The sensing logger 10a has, e.g. waterproof property and pressure resistance and can be used in environment other than normal environment, such as water and a high-pressure place.

The sensing logger 10a is driven by a battery (not shown) which is built in the sensing logger 10a. If the sensing logger 10a decreases in its battery remaining amount 7 while it is creating a log, it carries out wireless communications 8 with another sensing logger 10b to perform a process for transferring the log creation to the sensing logger 10b. Thus, the sensing logger 10b is placed in the same environment as the sensing logger 10a is. The sensing logger 10b has the same configuration as the sensing logger 10a has. The sensing logger 10b also has, e.g. waterproof property and pressure resistance and can be used in environment other than normal environment, such as water and a high-pressure place. To describe the sensing loggers 10a and 10b, hereinafter, they will be collectively called a sensing logger 10 when necessary.

For example, it is feared that the battery remaining amount 7 will become zero while only one sensing logger 10a is creating a log continuously for a long time in environment that makes it impossible to charge the sensing logger 10, such as the inside of freight in a ship or the like. It is thus necessary to transfer the log creation to the sensing logger 10b with appropriate timing before the battery remaining amount 7 becomes zero.

Assume the case where the sensing loggers 10a and 10b are placed together with freight. In this case, even though after a fixed period of time after the sensing logger 10a starts to create a log, the sensing logger 10b takes over the log creation using a timer or the like, if the battery of the sensing logger 10a is exhausted more quickly than expected, the sensing logger 10a stops its log operation before the sensing logger 10b starts to create a log; thus, no log can be created. It is thus necessary to take measures to transfer the creation of a log from the sensing logger 10a to the sensing logger 10b without interruption.

In the first embodiment, the log creation is transferred from the sensing logger 10a to the sensing logger 10b using a decrease in the battery remaining amount 7 as a trigger.

More specifically, assume the case where the battery remaining amount 7 of the sensing logger 10a decreases to a battery remaining amount 7b (e.g. 40%) which is smaller than a battery remaining amount 7a and then to a battery remaining amount 7c (e.g. 20%) which is smaller than the battery remaining amount 7b, as shown in FIG. 1. In this case, for example, wireless communication 8 with the sensing logger 10b is carried out using a decrease in the battery remaining amount 7 from the battery remaining amount 7b to the battery remaining amount 7c as a trigger. The sensing logger 10b starts to create a log using an establishment of the wireless communication 8 with the sensing logger 10a as a trigger and, in other words, the sensing logger 10b starts to take over the log creation from the sensing logger 10a.

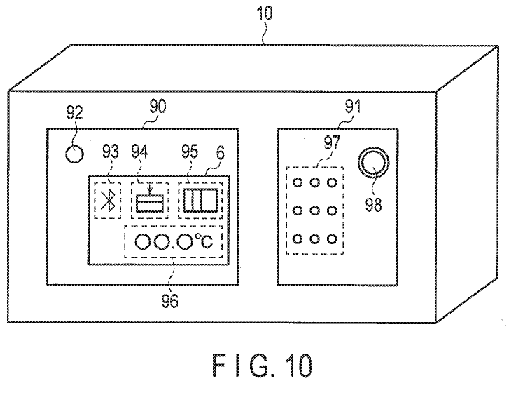

The sensing logger 10 or the sensing loggers 10a and 10b each includes a display screen 6 for displaying different items of information such as sensing information, as will be described with reference to FIG. 10.

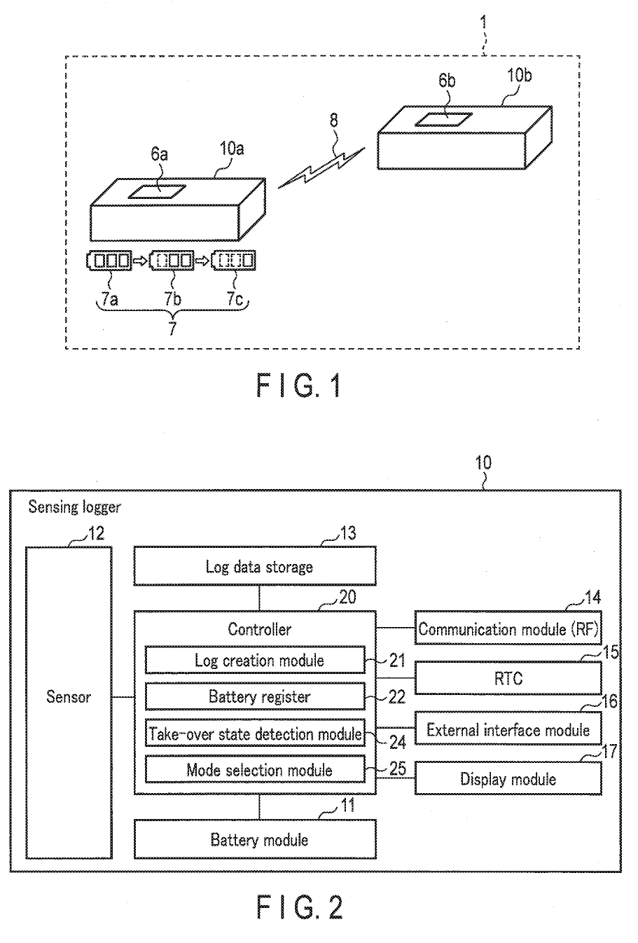

An example of the configuration of the sensing logger 10 according to the first embodiment will be described with reference to FIG. 2. Though the sensing loggers 10a and 10b have a similar configuration as described above, they may have different configurations as will be described in the last part of the first embodiment.

The sensing logger 10 includes a battery module 11, a sensor 12, a log data storage 13, a communication module (RF) 14, a real time clock (RTC) 15, an external interface module 16, a display module 17 and a controller 20.

The sensing logger 10 creates a log on the basis of a predetermined physical quantity measured by the sensor which will be described later, and records the created log. The predetermined physical quantity is, for example, atmospheric pressure, temperature, humidity, oscillation, acceleration, impact and light quantity.

The battery module 11 includes a battery (not shown) for driving the sensing logger 10. The battery is connected to the controller 20 and can be charged through the external interface module 16 connected to an external power source. In the first embodiment, however, it is assumed that the battery is not charged while the sensing logger 10 is creating a log.

The battery module 11 sends information indicative of a state of the battery, such as information about the battery remaining amount 7, to the controller 20.

The sensor 12 measures a predetermined physical quantity about a log to be created by the sensing logger 10. The sensor 12 includes an atmospheric pressure sensor, a temperature sensor, a humidity sensor, an oscillation sensor, an acceleration sensor, an impact sensor for sensing an impact on the sensing logger 10, and a light quantity sensor for sensing light quantity. The predetermined physical quantity measured by the sensor 12 is output to the controller 20 as an electrical signal.

The log data storage 13 is connected to the controller 20 and stores data (referred to as “log data” hereinafter) about a log created by a log creation module 21 provided in the controller 20 which will be described later. The log data storage 13 is a storage for recording log data as, e.g. a nonvolatile recording element.

The log data storage 13 sends, for example, information indicative of free space of the log data to the controller 20.

The communication module (RF) 14 carries out wireless communication with another sensing logger 10 (which corresponds to the sensing logger 10b when the sensing logger 10 is the sensing logger 10a). The wireless communication is, for example, Bluetooth®, WiFi® or Transfer Jet®. The communication module 14 is started, for example, in response to an instruction from the controller 20 and performs wireless communication. Hereinafter, a wireless communication available state will be referred to as “RF mode.” Unlike the power-on state (referred to as “power-on mode” hereinafter) of the sensing logger 10, the RF mode is, for example, a state in which only a function necessary for performing wireless communication is effective.

The communication module 14 also performs communication using, for example, Bluetooth® low energy. The Bluetooth® low energy is, for example, Bluetooth® of the version of four or more. Accordingly, for example, the sensing logger 10b that takes over the creation of a log need not always be driven in the power-on mode but can be driven in the RF mode which reduces power consumption to take over the log creation from the sensing logger 10a.

The RTC 15 has a function of continuing to show the current time, which is provided in a generally-used computer. For example, the RTC 15 continues to show the current time even though the sensing logger 10 is in a power-off state (referred to as “power-off mode” hereinafter).

Furthermore, the RTC 15 is used to cause the communication module 14 to carry out a synchronization process necessary for wireless communication between the sensing loggers 10a and 10b. More specifically, the controller 20, which will be described later, synchronizes time of the RTC 15 of the sensing logger 10a with that of the RTC 15 of the sensing logger 10b.

The external interface module 16 is an interface for connecting the sensing logger 10 to an external device. For example, it is an interface for connecting an external device such as a USB device to the sensing logger 10 to charge the sensing logger 10. The foregoing synchronization process can be performed using a USB device such as a USB hub.

The display module 17 has a function of displaying different items of information on the display screen 6. The display module 17 can be provided in the controller 20.

The controller 20 includes a log creation module 21, a battery register 22, a take-over state detection module 24 and a mode selection module 25.

The controller 20 is connected to the battery module 11, sensor 12, log data storage 13, communication module 14, RTC 15, external interface module 16 and display module 17.

When the take-over state detection module 24 detects a state in which the creation of a log is taken over to the sensing logger 10b (referred to as “take-over state” hereinafter), the controller 20 communicates with the sensing logger 10b through the communication module 14 to cause the sensing logger 10b to take over the log creation. The controller 20 is achieved as, for example, a microcomputer.

The log creation module 21 creates a log on the basis of a predetermined physical quantity measured by the sensor 12. More specifically, a predetermined physical quantity is processed as data and stored in, e.g. a register (not shown) provided in the log creation module 21. On the basis of the stored data, the log creation module 21 creates a log. The created log is sent to the log data storage 13 and stored therein. More specifically, log data is created in association with a predetermined physical quantity and time and the created log data is stored in the log data storage 13.

The battery register 22 acquires information about a battery remaining amount 7 and stores the battery remaining amount 7 on the basis of the information. This information is, for example, a voltage value of the battery or a variation in the voltage value. The information may contain information indicating a time-series variation of the battery remaining amount 7. The battery register 22 holds the acquired information about the battery remaining amount 7, the detected information indicating the battery remaining amount 7, or the like.

Furthermore, the battery register 22 need not detect the battery remaining amount 7 in real time. The battery register 22 has a fixed storage capacity, and sets a flag indicating that the voltage value decreases to change the flag from, e.g. “0” to “1” and record the battery remaining amount 7 or the flag.

The take-over state detection module 24 detects a take-over state as described above. For example, the take-over state detection module 24 detects a decrease in the battery remaining amount 7 as a take-over state. More specifically, the take-over state detection module 24 detects a take-over state in accordance with the battery remaining amount 7 detected by the battery register 22. For example, the take-over state detection module 24 detects a take-over state when the battery remaining amount 7 is smaller than a predetermined threshold value.

Assume here that the predetermined threshold value is a preset voltage value of the battery, e.g. 3.6 V. When the total capacity of the battery is, e.g. 4.1 V and the detected battery remaining amount 7 is smaller than 3.6 V, the take-over state detection module 24 determines that the battery is in a take-over state.

The predetermined threshold value can be determined by, for example, a preset percentage of the total capacity of the battery. In this case, the take-over state detection module 24 determines that a battery that is usable for about twenty-five days is in a take-over state when the preset percentage of a battery that can continuously be used for about fifty days is 50%.

The predetermined threshold value can be set in accordance with, for example, the rate of decrease in the battery remaining amount 7. The rate of decrease in the battery remaining amount 7 means, for example, the percentage of the total capacity of the battery which decreases in a given period of time to total capacity of the battery. In this case, the take-over state detection module 24 determines that the battery is in a take-over state when the rate of decrease in the battery remaining amount 7 is higher than a preset rate of decrease or the rate of decrease which is higher than the preset rate of decrease is continued for a given period of time.

The take-over state detection module 24 recognizes the battery to be in a take-over state when the sensor 12 senses an abnormal event. If an impact that is greater than expected is sensed by the impact sensor of the sensor 12 or light quantity that is not expected is sensed by the light quantity sensor of the sensor 12, the take-over state detection module 24 determines these detections as an abnormal event and determines that the battery is in a take-over state.

The take-over state detection module 24 may determines that the battery is in a take-over state even though the foregoing abnormal event is sensed by a sensor other than the impact sensor or light quantity sensor.

When the take-over state detection module 24 detects a take-over state, the controller 20 causes the communication module 14 to perform a process to try wireless communication at regular intervals during the creation of a log.

When the communication module 14 was not able to carry out wireless communication with the sensing logger 10b, the controller 20 may perform a process to stop trying the wireless communication by the communication module 14.

The mode selection module 25 performs a process to select one of the power-off mode, RF mode and power-on mode.

The sensor configured to measure a predetermined physical quantity in the claims corresponds to, for example, the sensor 12. The log creation module configured to create a log based on the predetermined physical quantity in the claims corresponds to, for example, the log creation module 21. The detection module configured to detect a take-over state that another data logger takes over creation of the log in the claims corresponds to, for example, the take-over state detection module 24. The communication module configured to communicate with said another data logger synchronized with the data logger in the claims corresponds to, for example, the RTC 15. The controller configured to perform a process to cause said another data logger to take over the creation of the log by communicating with said another data logger by the communication module when the take-over state is detected in the claims corresponds to, for example, the controller 20.

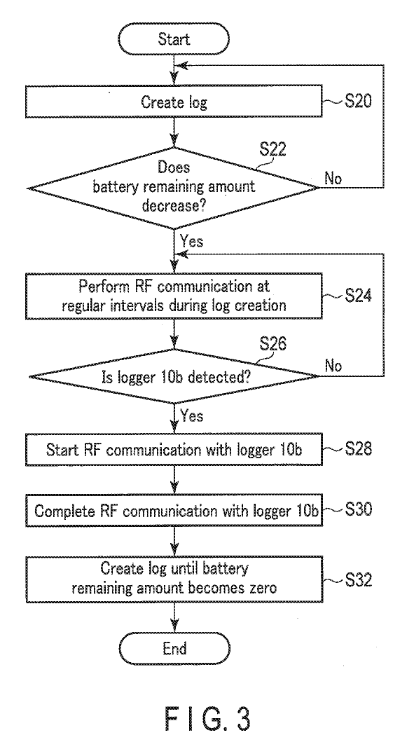

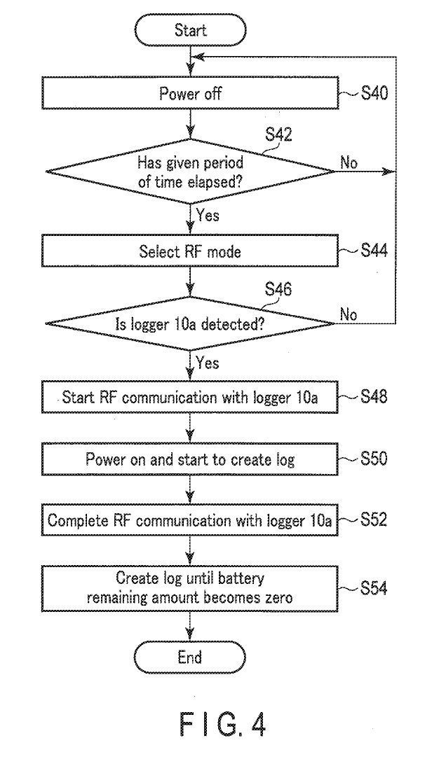

An example of a logger control procedure according to the first embodiment will be described with reference to FIGS. 3 and 4. This example will be described on the basis of the case where the sensing logger 10b takes over the creation of a log from the sensing logger 10a as illustrated in FIG. 1.

FIG. 3 is a flowchart showing an example of a logger control procedure to be performed by the sensing logger 10a of the first embodiment.

The sensing logger 10a starts a logger control process when the sensing logger 10a shifts from the power-off mode to the power-on mode. More specifically, the logger control process is started by depressing a power button 98 provided in the sensing logger 10a as will be described later with reference to FIG. 10.

The time of the sensing logger 10a and that of the sensing logger 10b are synchronized in advance by the RTC 15 of each of the sensing loggers. The synchronization allows the sensing loggers 10a and 10b to perform wireless communication at the same time as will be described later. The synchronization allows a sensing logger to take over a log created by another sensing logger and also allows a time-series variation of the log to be easily understood.

The sensing loggers 10a and 10b need not be paired in advance using Bluetooth®.

When a logger control process is started, the log creation module 21 starts to create a log (step S20)

The battery module 11 detects a battery remaining amount 7 and sends it to the battery register 22. The battery remaining amount 7 is recorded in the battery register 22. In accordance with the battery remaining amount 7, the controller 20 determines whether or not the battery register is in a take-over state, or whether or not the battery remaining amount 7 decreases (step S22). The battery register 22 may have a function of showing a decrease in the battery remaining amount 7 on, e.g. the display screen 6 as an indicator. In step S22, the controller 20 may determine whether the battery remaining amount 7 shown as an indicator decreases or not.

When the controller 20 determines that the battery remaining amount 7 does not decrease (No in step S22), the flow returns to step S20, in which the log creation is continued. When it determines that the battery remaining amount 7 decreases (Yes in step S22), the controller 20 causes the communication module 14 to perform a process to try wireless communication at regular intervals while the log creation module 21 continues the log creation (step S24). The regular intervals in step S24 may be, for example, several minutes, several hours or one day and, in other words, the communication module 14 tries wireless communication only at, e.g. several-minute intervals a day. Accordingly, the sensing logger 10 can be inhibited from decreasing in power consumption.

For example, the mode selection module 25 selects one of the power-on mode and the RF mode and thus these modes are switched to each other at regular intervals. The RF mode in the sensing logger 10a is set as a client of, e.g. Bluetooth® low energy to send a request for establishing wireless communication to the sensing logger 10b as a host. Furthermore, the RF mode in the sensing logger 10a includes a wireless communication available state in the power-on mode.

The controller 20 determines whether the sensing logger 10b is detected or not (step S26). When the controller 20 determines that the sensing logger 10b is not detected (No in step S26), the flow returns to step S24. When the number of times the controller 20 determines that the sensing logger 10b is not detected reaches a predetermined number of times, the controller 20 may cause the communication module 14 to perform a process to stop trying wireless communication. When it reaches the predetermined number of times, a timeout occurs, and the battery remaining amount 7 of, e.g. the sensing logger 10a can be inhibited from decreasing by stopping trying wireless communication. When it is unnecessary to take over the log creation, such as when, e.g. the sensing logger 10b is not placed in advance, the battery remaining amount 7 can be inhibited from decreasing.

Since the sensing loggers 10a and 10b are synchronized as described above, they can perform wireless communication and their connection can be established, for example, at the same time.

When the controller 20 determines that the sensing logger 10b is detected (Yes in step S26), the sensing logger 10a starts to carry out wireless communication with the sensing logger 10b (step S28). After the sensing logger 10a establishes a connection of wireless communication with the sensing logger 10b, the wireless communication with the sensing logger 10b is finished (step S30).

The take-over of the log creation to the sensing logger 10b is completed by establishing a connection of wireless communication with the sensing logger 10b by the sensing logger 10a in steps S28 and S30. Therefore, the sensing logger 10a need not send to the sensing logger 10b information about a log that has already been created by the sensing logger 10a after the sensing logger 10a establishes a connection of wireless communication with the sensing logger 10b. In other words, the sensing logger 10b starts to create a log using the establishment of a connection of wireless communication as a trigger

The log creation module 21 of the sensing logger 10a continues to create a log as long as possible. In other words, the sensing logger 10a continues to create a log until the battery remaining amount 7 becomes zero (step S32).

After step S30, the logger control process can be finished without performing the process of step S32. In other words, the logger control process can be finished when the sensing logger 10a completes wireless communication with the sensing logger 10b.

FIG. 4 is a flowchart showing an example of a logger control procedure to be performed by the sensing logger 10b of the first embodiment.

Unlike the logger control process to be performed by the sensing logger 10a, the logger control process to be performed by the sensing logger 10b is started from the power-off mode (step S40). As described above, in the power-off mode, the function of continuing to show the current time by the RTC 15 is in an active state. After step S40, therefore, the controller 20 determines whether a given period of time has elapsed (step S42). This determination process is performed in the power-off mode.

When the controller 20 determines that a given period of time does not elapse (No in step S42), the flow returns to step S40 to maintain the power-off mode. When it determines that a given period of time has elapsed (Yes in step S42), the mode selection module 25 switches the power-off mode to the RF mode (step S44). Thus, the mode selection module 25 selects one of the power-off mode and RF mode; thus, these modes are switched to each other at regular intervals. The RF mode in the sensing logger 10b is set as a host of, e.g. Bluetooth® low energy to search for the sensing logger 10a as a client.

The controller 20 determines whether the sensing logger 10a is detected or not (step S46). When the controller 20 determines that the sensing logger 10a is not detected (No in step S46), the flow returns to step S40, in which the mode selection module 25 switches the RF mode to the power-off mode. When the sensing logger 10a is not detected, for example, until the battery remaining amount 7 becomes zero, before the battery remaining amount 7 of the sensing logger 10b becomes smaller than the battery capacity necessary for performing wireless communication in the RF mode, the logger control process to be performed by the sensing logger 10b can be finished.

When the controller 20 determines that the sensing logger 10a is detected (Yes in step S46), wireless communication with the sensing logger 10a is started (step S48).

In accordance with the fact that wireless communication with the sensing logger 10a is started or a connection of wireless communication with the sensing logger 10a is established, the mode selection module 25 switches the sensing logger 10b from the RF mode to the power-on mode, and the sensing logger 10b starts to create a log (step S50). Thus, in the RF mode, the sensor 12 of the sensing logger 10b starts to measure a predetermined physical quantity using the establishment of wireless communication with the sensing logger 10a in the RF mode as a trigger.

The wireless communication with the sensing logger 10a is completed (step S52). The process of step S52 can be performed before the sensing logger 10b starts to create a log after the power-on mode is selected in step S50.

The log creation module 21 of the sensing logger 10b continues to create a log as long as possible. In other words, the log creation is continued until the battery remaining amount 7 of the sensing logger 10b becomes zero (step S54).

The sensing loggers 10a and 10b each have a configuration as shown in FIG. 2. For example, the sensing logger 10b need not include the battery register 22 or the take-over state detection module 24.

For example, the controller 20 of the sensing logger 10b is set as a central device in Bluetooth® low energy in the RF mode such that the communication module 14 of the sensing logger 10b communicates with the sensing logger 10a using Bluetooth® low energy. The controller 20 of the sensing logger 10a is set as a peripheral device in Bluetooth® low energy such that the communication module 14 of the sensing logger 10a communicates with the sensing logger 10b using Bluetooth® low energy.

When the sensing loggers 10a and 10b each have a configuration as shown in FIG. 2, for example, the sensing logger 10b can take over the log creation from the sensing logger 10a and then another sensing logger 10 (e.g. a sensing logger 10c not shown) can take over the log creation from the sensing logger 10b. In other words, the foregoing logger control process can be performed for n (n is three or more) sensing loggers 10 to take over the log creation from each of the sensing loggers 10.

In the first embodiment, it is assumed that a plurality of sensing loggers 10 are placed at once in the same environment, but for example, the sensing loggers 10a and 10b are placed in a predetermined environment and then the creation of a log is taken over and the sensing logger 10a is placed in another environment by a user or the like. Furthermore, it can be assumed that instead of the sensing logger 10a, the sensing logger 10c (not shown) is placed in the same environment as the sensing logger 10b.

The take-over state detected by the take-over state detection module 24 will be described in detail. The take-over state includes the following first to fifth states.

The first take-over state is a natural decrease state in which for example, the battery remaining amount 7 or the storage remaining amount decreases as expected and becomes smaller than a predetermined threshold value. This natural decrease state is detected by the take-over state detection module 24 that acquires an alarm indicating the battery remaining amount 7 or the storage remaining amount from the battery register 22 or the storage register 23 described later.

The second take-over state is an abnormal decrease state in which the battery remaining amount 7 or the storage remaining amount decreases earlier than expected. Though described in detail in the second embodiment, when the storage remaining amount of the log data storage 13 as a storage decreases abnormally, for example, the sensor 12 can measure a predetermined physical quantity. Since, however, a case where a log cannot be recorded is assumed, it is necessary to take over the creation of the log.

The third take-over state is a malfunction state in which, for example, the battery remaining amount 7 decreases due to a malfunction of the battery, the log data storage 13 as a storage, or the sensor 12. In this malfunction state, a case where information indicative of a malfunction of the battery is included in information indicative of a state of the battery sent to the controller 20 from the battery module 11 is assumed. When, for example, the sensor 12 malfunctions, log creation cannot be continued; thus, the log creation needs to be taken over. The malfunction state represents an abnormal state of, e.g. the battery and includes a state in which, e.g. the battery does not function normally.

The fourth take-over state is an abnormal event detection state in which an abnormal event is detected by the impact sensor or the like, as described above. In the abnormal event detection state, for example, the sensing logger 10a which detects an abnormal event needs to take over the log creation because it is assumed that a time period for which it can operate normally as the sensing logger 10 becomes shorter.

The fifth take-over state is a data abnormality state in which sensing information is abnormal. When the log data includes abnormal data, such as data that is broken and cannot be recovered, the controller 20 detects, e.g. an error and notifies the take-over state detection module 24 of the abnormal data.

As described above, according to the first embodiment, the log creation time period of a battery-driven sensing logger 10 can be extended by transferring the log creation from the sensing logger 10a to the sensing logger 10b with appropriate timing. More specifically, if the battery remaining amount 7 of a first sensing logger 10a decreases, the log creation can be taken over to a second sensing logger 10b. For example, even though the battery remaining amount 7 of the sensing logger 10a decreases earlier than expected, it is possible to avoid a period of time for which a log cannot be created.

### Second Embodiment

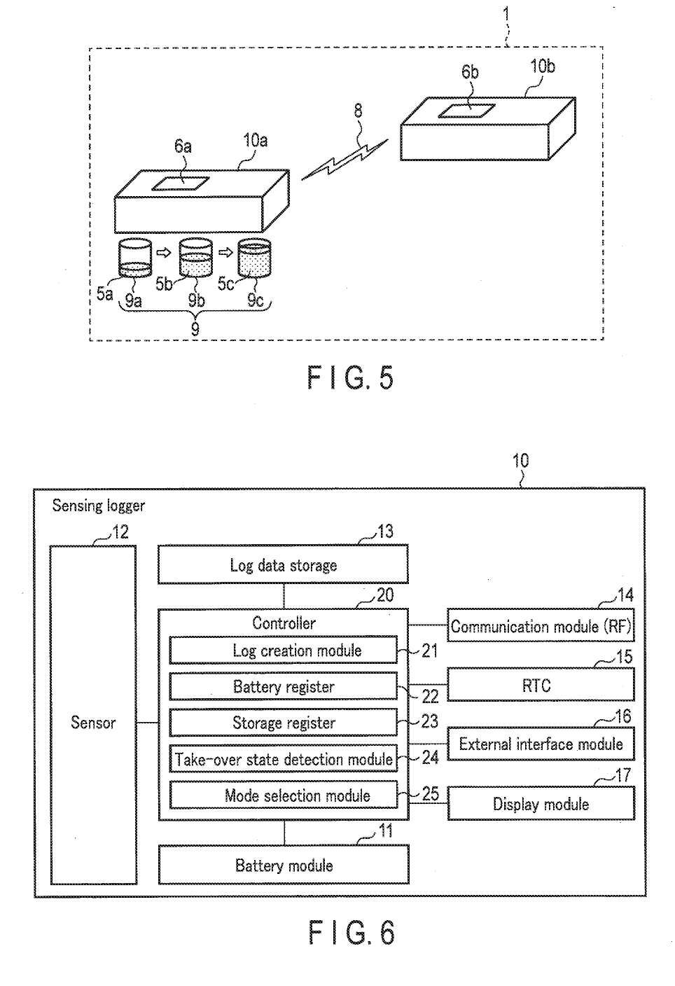

A second embodiment of the present invention will be described below with reference to FIGS. 5-8. The same configurations or contents as those in the first embodiment are denoted by the same reference numbers or same step numbers and their descriptions are omitted.

First, an overview of the second embodiment will be described with reference to FIG. 5. FIG. 5 is a diagram showing a logger control system 1 in the second embodiment.

In the second embodiment, when a storage remaining amount 9 decreases while a log is being created, a sensing logger 10a carries out wireless communication 8 with a sensing logger 10b to transfer the log creation to the sensing logger 10b.

In other words, in the second embodiment, the sensing logger 10b takes over the log creation from the sensing logger 10a using a decrease in the storage remaining amount 9 of the sensing logger 10a as a trigger.

More specifically, assume the case where the storage remaining amount 9 of the sensing logger 10a decreases to a storage remaining amount 9b (e.g. 50%) which is smaller than a storage remaining amount 9a and then to a storage remaining amount 9c (e.g. 20%) which is smaller than the storage remaining amount 9b, as shown in FIG. 5. In FIG. 5, the storage remaining amounts 9a, 9b and 9c are shown as capacities excluding used capacities 5a, 5b and 5c, respectively from the total capacity of the storage.

In this case, for example, wireless communication 8 with the sensing logger 10b is carried out using a decrease in the storage remaining amount 9 from the storage remaining amount 9b to the storage remaining amount 9c as a trigger. The sensing logger 10b starts to create a log using an establishment of the wireless communication 8 with the sensing logger 10a as a trigger and, in other words, the sensing logger 10b starts to take over the log creation from the sensing logger 10a.

An example of the configuration of the sensing logger 10 according to the second embodiment will be described with reference to FIG. 6.

The sensing logger 10 includes a storage register 23 in the controller 20 in addition to the structural elements shown in FIG. 2. In the second embodiment, the sensing logger 10 need not include a battery register 22.

The storage register 23 stores the storage remaining amount 9 on the basis of information indicative of free space (the storage remaining amount 9) of the log data acquired from the log data storage 13 having a function as a storage. The storage remaining amount 9 corresponds to a capacity excluding the capacity of stored log data, or the capacity 5 of used log data from the total capacity of the log data storage 13. The information indicating the storage remaining amount 9 may contain, for example, information indicating a time-series variation of the storage remaining amount 9. The storage register 23 holds, for example, information indicating the storage remaining amount 9.

The take-over state detection module 24 detects as a take-over state the fact that the storage remaining amount 9 detected by the storage register 23 is smaller than a predetermined threshold value.

The predetermined threshold value can be determined by, for example, a preset percentage of the total capacity of the log data storage 13. In this case, the take-over state detection module 24 determines that the storage that is usable for about twenty-five days is in a take-over state when the percentage of the storage which is used for about fifty days is assumed to be about 100% of the total capacity of the log data storage 13.

The predetermined threshold value can be set according to the rate of decrease in the storage remaining amount 9. In this case, for example, the take-over state detection module 24 determines that the storage is in a take-over state when the rate of decrease in the storage remaining amount 9 is higher than a preset rate of decrease or the rate of decrease which is higher than the preset rate of decrease is continued for a given period of time.

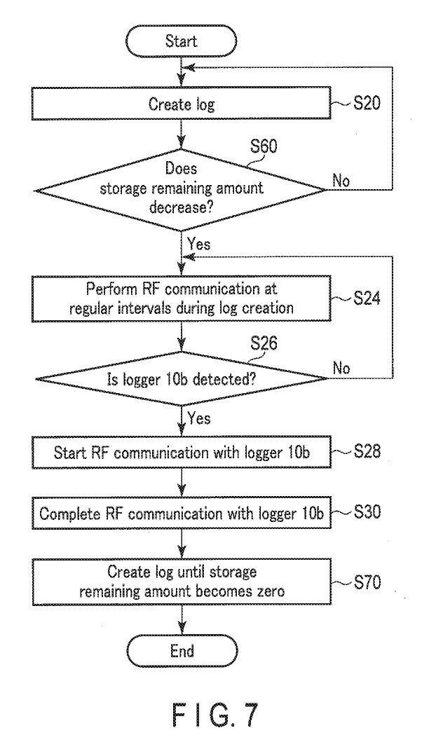

An example of a logger control procedure according to the second embodiment will be described with reference to FIG. 7. This example will be described on the basis of the case where the sensing logger 10b takes over the creation of a log from the sensing logger 10a as illustrated in FIG. 5. The same steps as those of the first embodiment are denoted by the same step numbers and their descriptions are omitted.

FIG. 7 is a flowchart showing an example of a logger control procedure to be performed by the sensing logger 10a of the second embodiment.

The logger control process of the second embodiment differs from that of the first embodiment in steps S60 and S70 described below.

The controller 20 determines whether the storage is in a take-over state or whether the storage remaining amount 9 decreases in accordance with the storage remaining amount 9 detected by the storage register 23 (step S60).

When the controller 20 determines that the storage remaining amount 9 does not decrease (No in step S60), the flow returns to step S20 and the log creation is continued. When the controller 20 determines that the storage remaining amount 9 decreases (Yes in step S60), the flow goes to step S24.

After step S30, the log creation is continued as long as possible by the log creation module 21 of the sensing logger 10a. In other words, the log creation is continued until the storage remaining amount becomes zero (step S70).

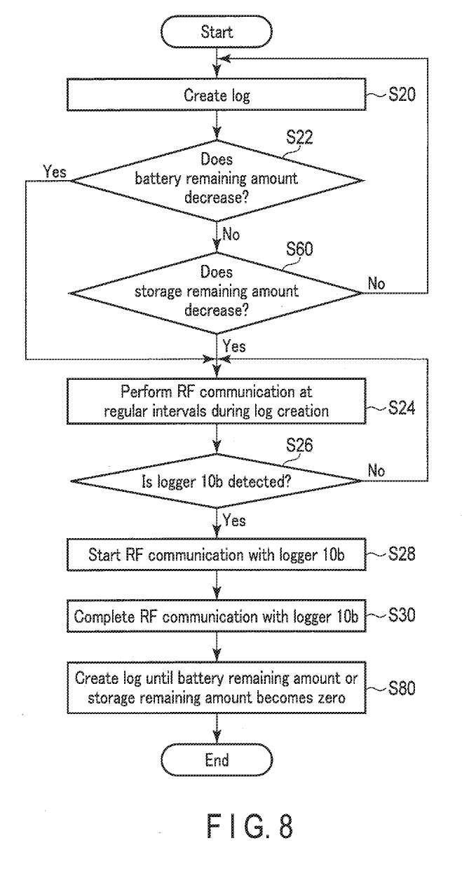

Another example of the logger control procedure according to the second embodiment will be described with reference to FIG. 8. This example will be described on the basis of the case where the sensing logger 10b takes over the creation of a log from the sensing logger 10a as illustrated in FIG. 5. The same steps as those of the first embodiment are denoted by the same step numbers and their descriptions are omitted.

FIG. 8 is a flowchart showing another example of the logger control procedure to be performed by the sensing logger 10a of the second embodiment.

The logger control process shown in FIG. 8 is based upon the case where the sensing logger 10b takes over the log creation in accordance with the battery remaining amount 7 and the storage remaining amount 9.

The process of step S22 is performed prior to that of step S60 in the logger control procedure shown in FIG. 7.

More specifically, after step S20, the controller 20 determines whether the battery is in a take-over state or whether the battery remaining amount 7 decreases in accordance with the battery remaining amount 7 detected by the battery register 22 (step S22).

When the controller 20 determines that the battery remaining amount 7 decreases (Yes in step S22), the flow goes to step S24. When the controller 20 determines that the battery remaining amount 7 does not decrease (No in step S22), the flow goes to step S60. The controller 20 determines whether the storage is in a take-over state or whether the storage remaining amount 9 decreases in accordance with the storage remaining amount 9 detected by the storage register 23 (step S60).

When the controller 20 determines that the storage remaining amount 9 does not decrease (No in step S60), the flow returns to step S20. In other words, when neither the battery remaining amount 7 nor the storage remaining amount 9 decreases, the sensing logger 10a continues to create a log without transferring the log creation to the sensing logger 10b.

When the controller 20 determines that the storage remaining amount 9 decreases (Yes in step S60), the flow goes to step S24.

In FIG. 8, the process of step S22 can be performed in place of that of step S60, and the process of step S60 can be performed in place of that of step S22.

After step S30, the log creation module 21 of the sensing logger 10a continues to create a log as long as possible and, in other words, the log creation is continued until the battery remaining amount 7 or the storage remaining amount 9 becomes zero (step S80).

When the controller 20 determines that the battery remaining amount 7 or the storage remaining amount 9 decreases in FIG. 8, the processes of steps S24 to S80 can be performed.

As described above, according to the second embodiment, the log creation time period of a battery-driven sensing logger 10 can be extended by transferring the log creation from the sensing logger 10a to the sensing logger 10b with appropriate timing. More specifically, if the controller 20 detects that the storage remaining amount 9 of a first sensing logger 10a decreases, the log creation can be taken over to a second sensing logger 10b. For example, even though the storage remaining amount 9 of the sensing logger 10a decreases earlier than expected, it is possible to avoid a period of time for which a log cannot be created.

Furthermore, for example, if the controller 20 detects that the battery remaining amount 7 and the storage remaining amount 9 of a first sensing logger 10a decrease, the log creation can be taken over to a second sensing logger 10b.

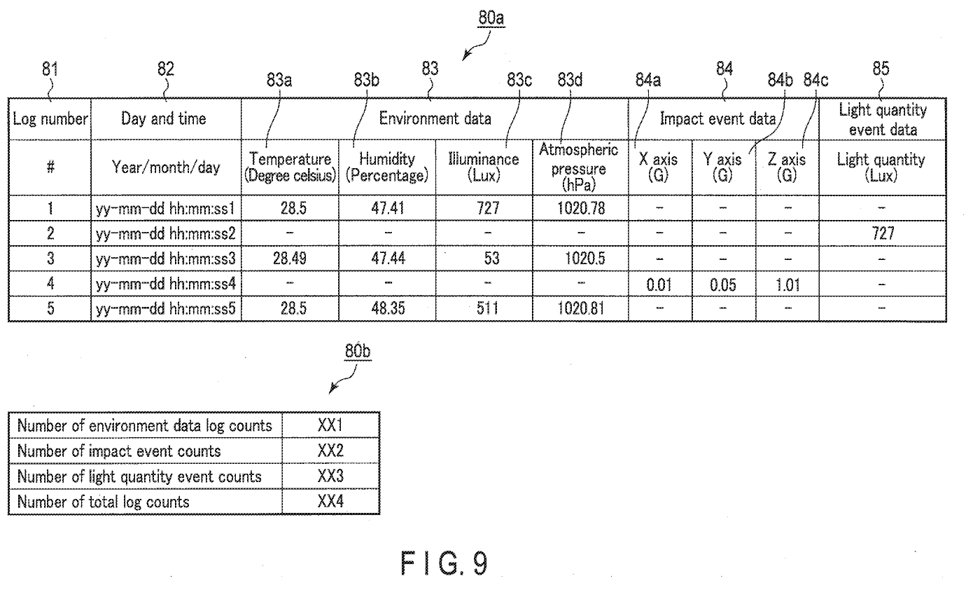

The log data stored in the log data storage 13, which is applied to the first and second embodiments, will be described below. FIG. 9 shows an example of log data tables 80a and 80b indicating log data.

The log data table 80a includes a log number item 81, a date and time item 82, an environment data item 83, an impact event data item 84 and a light quantity event data item 85.

The log number item 81 indicates information about a number for identifying a created log.

The date and time item 82 indicates information about a date and time including a year/month/day when a log is created or information about a date and time including a year/month/day when log data is stored in the log data storage 13.

The environment data item 83 indicates climate information or environment information of the sensing information acquired by the sensing logger 10. As shown in FIG. 9, the environment data item 83 includes a temperature item 83a, a humidity item 83b, an illuminance item 83c and an atmospheric pressure item 83d. The temperature item 83a indicates temperature sensed by the temperature sensor of the sensor 12. The humidity item 83b indicates humidity sensed by the humidity sensor of the sensor 12. The illuminance item 83c indicates illuminance sensed by the illuminance sensor of the sensor 12, such as a light quantity sensor. The atmospheric pressure item 83d indicates atmospheric pressure sensed by the atmospheric pressure sensor of the sensor 12.

The impact event data item 84 indicates information about an impact acquired as an abnormal event by the impact sensor of the sensor 12. In FIG. 9, the impact event data item 84 includes an x-axis impact item 84a, a y-axis impact item 84b and a z-axis impact item 84c indicating information about impacts in x-axis, y-axis and z-axis directions which are predetermined for the sensing logger 10.

The light quantity event data item 85 indicates information about light quantity acquired as an abnormal event by the light quantity sensor of the sensor 12.

More specifically, as indicated in the log data table 80a in FIG. 9, there is a one-to-one correspondence among the log number item 81, date and time item 82, environment data item 83, impact event data item 84 and light quantity event data item 85.

For example, the log data about log number # “1” indicates “yy-mm-dd hh:mm:ss1” as a date and time when a created log is acquired and also indicates temperature of “28.5(° C.),” humidity of “47.41(%),” illuminance of “727 (Lux)” and atmospheric pressure of “1020.78 (hPa)” as the environment data.

The log data about log number # “2” indicates “yy-mm-dd hh:mm:ss2” as a date and time when a created log is acquired and also indicates light quantity of “727 (Lux)” as the light quantity event data.

The log data about log number # “4” indicates “yy-mm-dd hh:mm:ss4” as a date and time when a created log is acquired and also indicates an x-axis direction impact of “0.01 (G),” a y-axis direction impact of “0.05 (G)” and a z-axis direction impact of “1.01 (G)” as the impact event data.

Data about the environment data item 83 is acquired, for example, at regular intervals and created as a log. Data about the impact event data item 84 or data about the light quantity event data item 85 is created as a log when, for example, an abnormal event occurs.

Next, the log data table 80b will be described.

The log data table 80b shows collected information of information items shown in the log data table 80a, or more specifically, the number of environment data log counts, the number of impact event counts, the number of light quantity event counts and the number of total log counts.

The number of environment data log counts “xx1” represents the number of log counts recorded in the environment data item 83. In FIG. 9, for example, “xx1” corresponds to “3.”

The number of impact data log counts “xx2” represents the number of log counts recorded in the impact event data item 84. In FIG. 9, for example, “xx2” corresponds to “1.”

The number of light quantity data log counts “xx3” represents the number of log counts recorded in the light quantity data item 85. In FIG. 9, for example, “xx3” corresponds to “1.”

The number of total log counts “xx4” represents the total number of log counts of “xx1,” “xx2” and “xx3.” In FIG. 9, for example, “xx4” corresponds to “5.”

The log data tables 80a and 80b shown in FIG. 9 are prepared using, e.g. a communication tool for converting a log recorded in terms of binary data into data such as CSV.

The outward appearance of the sensing logger 10 will be described with reference to FIG. 10. FIG. 10 is a perspective view showing an example of the outward appearance of the sensing logger 10.

The sensing logger 10 includes, for example, two regions 90 and 91. The region 90 includes a display screen 6 and a light quantity sensor 92. The region 91 includes a power button 98 for starting the sensing logger 10 and air holes 97 formed for the sensor 12 for sensing a predetermined physical quantity from air, such as the temperature sensor (not shown). For example, the light quantity sensor 92 can be included in the region 91.

The light quantity sensor 92 is so provided that it can be viewed from outside to sense a variation in light quantity in the environment where the sensing logger 10 is placed.

The display screen 6 includes a wireless communication connection display region 93 indicating whether a connection of wireless communication such as Bluetooth® is established, a log creating display region 94 indicating whether a log is created, a battery remaining amount display region 95 indicating the battery remaining amount 7, and a sensing information display region 96 displaying sensing information acquired by the sensing logger 10.

The power button 98 may have, for example, a function of setting the sensing logger 10 in the power-off mode and a function of selecting one of a valid state in which wireless communication is valid and an invalid state in which wireless communication is invalid, as well as a function of starting the sensing logger 10 and setting it in the power-on mode.

Furthermore, the logger control system 1 according to the first and second embodiments as described above is achieved by a computer such as a server whose operation is controlled by, for example, programs recorded on a recording medium such as a magnetic disk and programs downloaded via a communication network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data logger driven by a battery, comprising:
a sensor configured to measure a predetermined physical quantity;
a log creation module configured to create a log based on the predetermined physical quantity;
a detection module configured to detect a take-over state that another data logger takes over creation of the log;
a communication module configured to communicate with said another data logger synchronized with the data logger; and
a controller configured to perform a process to cause said another data logger to take over the creation of the log by communicating with said another data logger by the communication module when the take-over state is detected by the detection module.

2. The data logger according to claim 1, further comprising a storage configured to store the log,
wherein the detection module is configured to detect one of first state that a remaining amount of the battery decreases, second state that a remaining amount of the storage is smaller than a predetermined value, and third state that the sensor malfunctions, as the take-over state.

3. The data logger according to claim 1, wherein the controller is configured to cause the communication module to perform communication at regular intervals while the log creation module is creating a log.

4. The data logger according to claim 1, wherein the controller is configured to stop causing the communication module to perform communication when the communication module is unable to communicate with said another data logger.

5. The data logger according to claim 1, wherein:
the sensor comprises one of an impact sensor configured to sense an impact on the data logger and a light quantity sensor configured to sense light quantity; and
the detection module configured to detect one of sensing of the impact by the impact sensor and sensing of the light quantity by the light quantity sensor, as the take-over state.

6. A computer-readable storage medium storing instructions that cause a computer incorporated in a data logger driven by a battery to:
cause a sensor to measure a predetermined physical quantity;
cause a storage to create a log provided in the data logger based on the predetermined physical quantity;
cause a controller provided in the data logger to perform control for the controller detecting a take-over state that another data logger takes over creation of the log; and
cause said another data logger synchronized with the data logger to perform a process to take over the creation of the log when the take-over state is detected.

7. The computer-readable storage medium of claim 6, wherein the take-over state is one of first state that a remaining amount of the battery decreases, second state that a remaining amount of the storage decreases and third state in which the sensor malfunctions.

8. The computer-readable storage medium of claim 6, wherein the performing the process comprises carrying out communication with said another data logger at regular intervals while the log is being created and using a state in which the communication is established as a trigger.

9. The computer-readable storage medium of claim 6, wherein the performing the process comprises stopping the process when communication with said another data logger is not carried out.

10. The computer-readable storage medium of claim 6, wherein when the sensor is one of an impact sensor configured to sense an impact on the data logger and a light quantity sensor configured to sense light quantity, the take-over state is one of first state that the impact sensor senses an impact that is equal to or greater than a predetermined amount and second state that the light quantity sensor senses light quantity that is equal to or greater than a predetermined amount.

11. A data logger driven by a battery, comprising:
a sensor configured to measure a predetermined physical quantity;
a log creation module configured to create a log based on the predetermined physical quantity;
a communication module configured to communicate with another data logger synchronized with the data logger;
a selection module configured to select one of the power-off mode of the data logger and a communication mode at regular intervals, from among the power-off mode, a power-on mode of the data logger and the communication mode, wherein the communication mode is a mode that the data logger is allowed to communicate with said another data logger and that differs from the power-off mode and the power-on mode; and
a controller configured to start to cause the sensor to measure the predetermined physical quantity when communication with said another data logger is established in the communication mode.
